(19) United States
(12) Patent Application Publication
(10) Pub. No.: US 2021/0340892 A1
(43) Pub. Date: Nov. 4, 2021

(54) APPARATUS AND METHOD FOR DETECTING ENGINE OIL REPLACEMENT

(71) Applicants: Hyundai Motor Company, Seoul (KR); Kia Motors Corporation, Seoul (KR)

(72) Inventors: Hyuk Im, Suwon-si (KR); Joowon Lee, Yongin-si (KR); Kiwon Park, Seoul (KR); Jinnam Kim, Gunpo-si (KR)

(73) Assignees: Hyundai Motor Company, Seoul (KR); Kia Motors Corporation, Seoul (KR)

(21) Appl. No.: 17/070,455

(22) Filed: Oct. 14, 2020

(30) Foreign Application Priority Data
Apr. 29, 2020 (KR) 10-2020-0052537

(51) Int. Cl. F01M 11/10

(52) U.S. Cl. CPC F01M 11/10; F01M 2250/00; F01M 2011/1473

(57) ABSTRACT

A method for detecting engine oil replacement may include determining a measured oil temperature change amount based on an engine oil temperature measurement value during an engine turned-off period determined based on turning-off/on signals, determining a modeled oil temperature change amount based on a temperature change model estimating the engine oil temperature without an engine oil replacement event according to the engine turned-off period, temperature information related to the engine at an engine turned-off time point, and temperature information related to the engine at a turned-on time point, comparing a difference value between the measured oil temperature change amount and the modeled oil temperature change amount with a reference temperature, determining whether the engine oil replacement event has occurred during the engine turned-off period based on a comparison result, and resetting an engine oil replacement timing and displaying the reset engine oil replacement timing in a user interface.

### CROSS-REFERENCE TO RELATED APPLICATION

The present application claims priority to Korean Patent Application No. 10-2020-0052537 filed on Apr. 29, 2020, the entire contents of which is incorporated herein for all purposes by this reference.

### BACKGROUND OF THE INVENTION

### Field of the Invention

The present invention relates to an apparatus and method for detecting replacement of engine oil.

### Description of Related Art

Engine oil flows inside the engine and acts as friction reduction, cooling, sealing, stress distribution, and cleaning. Particularly, engine oil reduces frictional resistance caused by metals contacting each other in a reciprocating portion such between as a cylinder and a piston of the engine, or in a rotation portion such as between a crankshaft and a camshaft.

Engine oil that has reached its lifetime has a weak viscosity and may deteriorate engine performance, so it may be replaced after a certain time period. If the engine oil is not replaced at the right time, problems such as deteriorated fuel consumption, sludge of oil debris, and bearing damage may occur.

However, the engine oil replacement cycle may vary depending on a driving style of the driver or on a vehicle type.

That is, an engine oil replacement cycle may vary from vehicle to vehicle depending on driving circumstances and driver tendency. Therefore, the driver may change the engine oil by determining the engine oil replacement cycle, i.e., next replacement timing, by himself/herself. If the driver does not separately note an adjacent engine replacement timing, engine oil replacement possibly cannot be performed in a timely manner, which may cause problems such as deterioration of engine performance.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an exemplary method for detecting engine oil replacement including determining a measured oil temperature change amount based on an engine oil temperature measurement value during an engine turned-off period determined based on turning-off/on signals of an engine, determining a modeled oil temperature change amount based on a temperature change model that estimates an engine oil temperature without an engine oil replacement event according to the engine turned-off period, temperature information related to the engine at an engine turned-off time point, and temperature information related to the engine at a turned-on time point of the engine, comparing a difference value between the measured oil temperature change amount and the modeled oil temperature change amount with a reference temperature, determining whether the engine oil replacement event has occurred during the engine turned-off period based on a comparison result, and resetting an engine oil replacement timing and displaying the reset engine oil replacement timing in a user interface.

The determining of whether the engine oil replacement event has occurred may include determining that the engine oil replacement event has occurred when a difference value between the measured oil temperature change amount and the modeled oil temperature change amount exceeds the reference temperature. The measured oil temperature change amount may be a maximum temperature change amount determined based on the engine oil temperature measurement value. The modeled oil temperature change amount may be a maximum temperature change amount determined based on the engine oil temperature estimated by the temperature change model.

The exemplary method may further include, prior to the determining the measured oil temperature change amount based on the engine oil temperature measurement value and prior to the determining the modeled oil temperature change amount based on the temperature change model, determining whether a diagnosis condition for determining whether the engine oil replacement has occurred is satisfied. Here, the diagnosis condition may include at least one condition of a condition that the engine turned-off period is within a predetermined reference period, a condition that a sensor connected to the controller and configured for detecting the engine oil temperature is in a normal state, and a condition that the engine oil temperature at the engine turned-off time point is above a predetermined reference temperature.

The determining that the engine oil replacement event has occurred may include storing engine oil replacement information in a memory.

The temperature information related to the engine may include at least one of an ambient temperature, a coolant temperature, and an engine oil temperature.

An apparatus of detecting engine oil replacement includes an electronic control device determining an engine turned-off period, and determining whether a replacement event of engine oil has occurred during the engine turned-off period, and a temperature change model that estimates an engine oil temperature without the engine oil replacement event based on the engine turned-off period, temperature information related to the engine at an engine turned-off time point, and temperature information related to the engine at a turned-on time point of the engine. The electronic control device may determine whether the engine oil replacement event has occurred by comparing a reference temperature with a difference value between a measured oil temperature change amount determined based on the engine oil temperature measurement value and a modeled oil temperature change amount determined based on the temperature change model.

The electronic control device may be configured to periodically receive the engine oil temperature from a temperature sensor that is configured to measure the engine oil temperature, determine a plurality of temperature change amounts for unit time during the engine turned-off period, and determine the measured oil temperature change amount as a maximum temperature change amount among the plurality of temperature change amounts.

The electronic control device may be configured to estimate an engine oil temperature change during the engine turned-off period using the temperature change model, determine a plurality of temperature change amounts for unit based on the estimated engine oil temperature, and determine the modeled oil temperature change amount as a maximum temperature change amount among the plurality of temperature change amounts.

The temperature information related to the engine may include at least one of an ambient temperature, a coolant temperature, and an engine oil temperature.

The electronic control device may determine that the engine oil replacement event has occurred when a difference value between the measured oil temperature change amount and the modeled oil temperature change amount exceeds the reference temperature.

The electronic control device may store engine oil replacement information in a memory, reset engine oil replacement timing, and display the reset engine oil replacement timing to a user interface.

The electronic control device may determine whether the engine oil replacement event has occurred when the diagnosis condition is satisfied. The diagnosis condition may include at least one condition of a condition that the engine turned-off period is within a predetermined reference period, a condition that a sensor connected to the controller and configured for detecting the engine oil temperature is in a normal state, and a condition that the engine oil temperature at the engine turned-off time point is above a predetermined reference temperature.

According to various exemplary embodiments of the present invention, the replacement of engine oil may be monitored and recorded to be used as analysis data for various maintenance problems occurring in the engine.

According to various exemplary embodiments of the present invention, an engine oil replacement may be detected and a next engine oil replacement timing may be provided to a driver such that the engine may be efficiently maintenance.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a system for detecting engine oil replacement according to an exemplary embodiment of the present invention.

FIG. 2 is a flowchart illustrating a method for detecting engine oil replacement according to an exemplary embodiment of the present invention.

FIG. 3 is an exemplary graph showing the engine oil temperature change during an engine turned-off period according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments included in the exemplary embodiment will be described in detail with reference to the accompanying drawings. In the exemplary embodiment, the same or similar components will be denoted by the same or similar reference numerals, and a repeated description thereof will be omitted. Terms “module” and/or “unit” for components used in the following description are used only to easily describe the specification. Therefore, these terms do not have meanings or roles that distinguish them from each other in and of themselves. In describing exemplary embodiments of the exemplary embodiment, when it is determined that a detailed description of the well-known art associated with the present invention may obscure the gist of the present invention, it will be omitted. The accompanying drawings are provided only to allow exemplary embodiments included in the exemplary embodiment to be easily understood and are not to be interpreted as limiting the spirit included in the exemplary embodiment, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It is to be understood that when one component is referred to as being “connected” or “coupled” to another component, it may be connected or coupled directly to the other component or may be connected or coupled to the other component with a further component intervening therebetween. Furthermore, it is to be understood that when one component is referred to as being “directly connected” or “directly coupled” to another component, it may be connected or coupled directly to the other component without a further component intervening therebetween.

It will be further understood that terms “comprises” and “have” used in the exemplary embodiment specify the presence of stated features, numerals, steps, operations, components, parts, or combinations thereof, but do not preclude the presence or addition of one or more other features, numerals, steps, operations, components, parts, or combinations thereof.

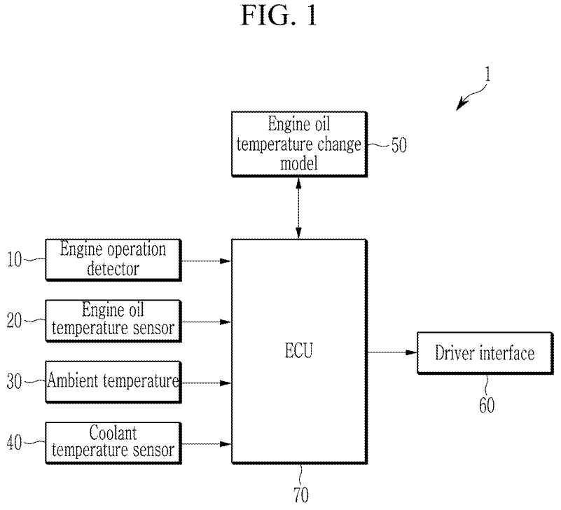

FIG. 1 is a block diagram illustrating a system for detecting engine oil replacement according to an exemplary embodiment of the present invention.

Referring to FIG. 1, a system for detecting engine oil replacement 1 includes an engine operation detector 10, an engine oil temperature sensor 20, an ambient temperature sensor 30, a coolant temperature sensor 40, a temperature change model 50, a driver interface 60, and an ECU 70.

The engine operation detector 10 sends an engine rotation signal to the ECU 70 such that the ECU 70 may determine or recognize whether the engine is running (turned on) or not (turned off). For example, the engine operation detector 10 may be a crank position sensor that detects an angular position of a crankshaft such that the ECU 70 may determine whether the engine is operating (i.e., rotating). As a variation, the engine operation detector 10 may be a separate sensor to detect rotation of the engine and may send a signal indicating whether the engine is rotating, to the ECU 70.

The engine oil temperature sensor 20 measures a temperature of the engine oil circulating within the engine every predetermined period, and may transmit a signal indicating a measured engine oil temperature to the ECU 70. The temperature of the engine oil that circulates in a vehicle is higher than an ambient temperature, i.e., an atmospheric temperature, by the heat generated by the engine. According to various exemplary embodiments of the present invention, when new engine oil in the ambient temperature is poured into the engine as a replacement of the engine oil, the temperature of the entire engine oil in the engine is lowered. When the engine is turned on, i.e., started, after the engine oil replacement, low temperature engine oil circulates through the engine, and then rapidly heated by heat generated from the engine.

The ambient temperature sensor 30 measures the ambient temperature, which is the temperature of the atmosphere outside the engine, at predetermined periods, and transmits a signal indicating the measured ambient temperature to the ECU 70.

The coolant temperature sensor 40 measures, by a predetermined period, the temperature of a coolant that cools the heat generated in the engine by flowing through the engine block, and may transmit a signal indicating the measured coolant temperature to the ECU 70. For example, the coolant temperature sensor 40 may be disposed at a thermostat that opens and closes a coolant path through the engine.

Based on an engine turned-off period of the vehicle, temperature information related to the engine at an engine turned-off time point, and temperature information related to the engine at an engine turned-on time point, the temperature change model 50 estimates an engine oil temperature change during the engine turned-off period. According to various exemplary embodiments of the present invention, the temperature change model 50 estimates the engine oil temperature change during the engine turned-off period based on the environment in the engine on the premise that there is no occurrence of an engine oil replacement event. At the instant time, the temperature information related to the engine input to the temperature change model 50 may include at least one of an ambient temperature, a coolant temperature, and an engine oil temperature.

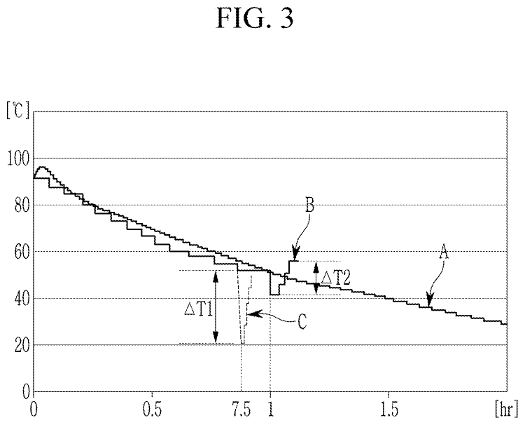

Referring to graph A in FIG. 3, in the case that the ambient temperature is 0° C. and the engine oil temperature at the engine turned-off time point is approximately 90° C., according to the temperature change model 50, the engine oil temperature gradually decreases after the engine is turned off, to approximately 30° C. for example after 2 hours of the engine turned-off period.

The driver interface 60 transmits the engine oil replacement timing received from the ECU 70 to the driver. For example, the driver interface 60 may include an instrument panel (instrument cluster), and may display an engine oil replacement timing received from the ECU 70 in an oil replacement pop-up window in the cluster.

During the engine turned-off period, the ECU 70 may compare a measured oil temperature change amount based on an engine oil temperature measurement value with engine oil modeled oil temperature change amount based on the temperature change model to detect an engine oil replacement, and may store engine oil replacement information in a memory. The engine oil replacement information may include information such as an engine oil replacement time point (i.e., a time point when a next engine oil replacement is required), an engine oil replacement mileage (i.e., a mileage of the vehicle where the next engine oil replacement is required), etc.

Thus, the term engine oil replacement timing used in the present disclosure may be interpreted to indicate any or both of the engine oil replacement time point and the engine oil replacement mileage.

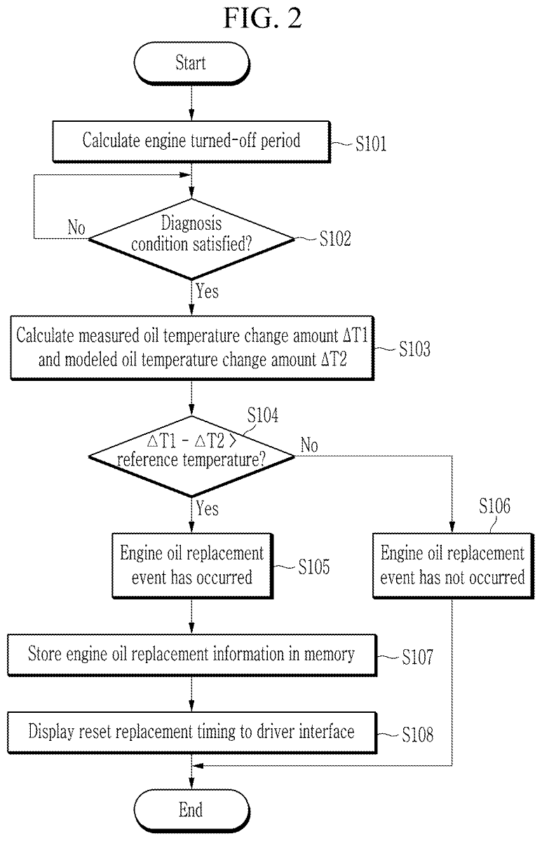

FIG. 2 is a flowchart illustrating a method for detecting engine oil replacement according to an exemplary embodiment of the present invention.

FIG. 3 is an exemplary graph showing the engine oil temperature change during an engine turned-off period according to an exemplary embodiment of the present invention.

Hereinafter, an apparatus and method for detecting engine oil replacement according to an exemplary embodiment will be described with reference to FIG. 2 and FIG. 3.

Firstly at step S101, the ECU 70 determines an engine turned-off period during which the engine is turned off, in the case that the engine turned-off time point and the engine turned-on time point are sequentially recognized. As discussed above with reference to with FIG. 1, the ECU 70 may recognize turning-on and turning-off of the engine based on the signal from the engine operation detector 10. At the instant time, the ECU 70 may determine the engine turned-off period as a difference value from the engine turned-off time point to the engine turned-on time point.

Subsequently at step S102, the ECU 70 determines whether a diagnosis condition for determining whether the engine oil replacement has occurred during the engine turned-off period is satisfied. According to various exemplary embodiments of the present invention, the diagnosis condition may include at least one condition of a condition that the engine turned-off period is within a predetermined reference period, a condition that the engine oil temperature sensor 20 detecting the engine oil temperature is in a normal state, and a condition that the engine oil temperature at the engine turned-off time point is above a predetermined reference temperature.

Subsequently at step S103, the ECU 70 determines a measured oil temperature change amount based on an engine oil temperature measurement value ΔT1 and a modeled oil temperature change amount ΔT2 based on the temperature change model 50 during the engine turned-off period.

When the engine is turned off, engine rotation stops, and therefore, the temperature of the engine oil circulating through the engine gradually decreases according to the ambient temperature. That is, during the engine turned-off period without the engine oil replacement, the engine oil temperature gradually decreases to the ambient temperature. However, when the replacement of engine oil has been performed by engine oil in the ambient temperature, the temperature of the entire engine oil in the engine is suddenly lowered. Afterwards, when the engine is turned on again (the ECU 70 receives the engine rotation signal again), the temperature of the engine oil starting circulation through the engine rapidly increases from the initial low temperature. That is, if there is replacement of engine oil during the engine turned-off period, a rapid temperature change of engine oil circulating through the engine may be detected.

The ECU 70 may determine a plurality of temperature change amounts for unit time during the engine turned-off period based on engine the oil temperature received from the engine oil temperature sensor 20, and determine a measured oil temperature change amount ΔT1 as a maximum temperature change amount among the plurality of temperature change amounts.

The ECU 70 estimates the engine oil temperature change during the engine turned-off period, by inputting the engine turned-off period, temperature information at the engine turned-off time point, and temperature information at the engine turned-on time point to the temperature change model 50. The ECU 70 may determine a plurality of temperature change amounts for unit time during the engine turned-off period based on the engine oil temperature change estimated through the temperature change model 50, and determine a modeled oil temperature change amount ΔT2 as a maximum temperature change amount among the plurality of temperature change amounts. For example, the modeled oil temperature change amount ΔT2 may be determined in synchronization with the engine turned-off time point.

Referring to FIG. 3, on the premise that the ambient temperature is 0° C. and the engine oil temperature at the engine turned-off time point is approximately 90° C., graph A is an example showing the engine oil temperature change without engine restarting for 2 hours. Graph B is another example showing the engine oil temperature change without engine oil replacement when the engine is restarted about 60 minutes after being turned off. Graph C is an example showing the engine oil temperature change when the engine oil is replaced and then the engine is restarted at about 45 minutes after the engine is turned off. According to various exemplary embodiments of the present invention, the graph A and the graph B may be derived using the temperature change model 50. The graph C may be derived based on the engine oil temperature received from the engine oil temperature sensor 20. For example, referring to FIG. 3, the ECU 70 may determine the temperature change amount ΔT1 indicated in the graph C as the measured oil temperature change amount. The ECU 70 may determine the temperature change amount ΔT2 indicated in the graph B as the modeled oil temperature change amount.

Subsequently at step S104, the ECU 70 determines whether a difference value between a measured oil temperature change amount ΔT1 and a modeled oil temperature change amount ΔT2 exceeds a reference temperature. At the instant time, the reference temperature may be set as a maximum value of a difference between a measured oil temperature change amount ΔT1 and a modeled oil temperature change amount ΔT2 which may occur when the engine oil replacement event does not occur.

For example, when there has been an engine oil replacement, the measured oil temperature change amount and the modeled oil temperature change amount may be determined based on graph C and graph B shown in FIG. 3, and a difference value between the measured oil temperature change amount and the modeled oil temperature change amount may exceed the reference temperature. For another example, when there has not been an engine oil replacement, the engine oil temperature change during the engine turned-off period may show a pattern similar to graph B of FIG. 4. Therefore, the difference value between the measured oil temperature change amount ΔT1 determined based on an actual temperature measurement value and the modeled oil temperature change amount ΔT2 determined based on the temperature change model 50 may be below the reference temperature.

Subsequently when the difference value between the measured oil temperature change amount ΔT1 and the modeled oil temperature change amount ΔT2 exceeds the reference temperature (S104—Yes), the ECU 70 determines, at step S105, that there has been an engine oil replacement during the engine turned-off period.

Then at step S107, the ECU 70 stores engine oil replacement information, such as a vehicle mileage at the engine oil replacement time point, into the memory.

At step S108, the ECU 70 may reset the engine oil replacement timing, i.e., vehicle mileage and/or time point for a next engine oil replacement, and may display the reset engine oil replacement timing to the driver interface 60.

Subsequently, when the difference value between the measured oil temperature change amount ΔT1 and the modeled oil temperature change amount ΔT2 does not exceed the reference temperature (S104—No), the ECU 70 determines that there has not been an engine oil replacement during the engine turned-off period.

Furthermore, the term “controller”, “control device” or “control unit” refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The controller or the control unit may be at least one microprocessor operated by a predetermined program which may include a series of commands for carrying out a method in accordance with various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method of detecting engine oil replacement, the method comprising:
determining, by a controller, a measured oil temperature change amount according to an engine oil temperature measurement value during an engine turned-off period determined according to turning-off/on signals of an engine;
determining, by the controller, a modeled oil temperature change amount according to a temperature change model that estimates an engine oil temperature without an engine oil replacement event according to the engine turned-off period, temperature information related to the engine at an engine turned-off time point, and temperature information related to the engine at a turned-on time point of the engine;
comparing, by the controller, a difference value between the measured oil temperature change amount and the modeled oil temperature change amount with a reference temperature;
determining, by the controller, whether the engine oil replacement event has occurred during the engine turned-off period according to a result of the comparing; and
resetting, by the controller, an engine oil replacement timing and displaying the reset engine oil replacement timing in a user interface.

2. The method of claim 1, wherein the determining of whether the engine oil replacement event has occurred includes:
determining that the engine oil replacement event has occurred upon concluding that the difference value between the measured oil temperature change amount and the modeled oil temperature change amount is greater than the reference temperature.

3. The method of claim 2,
wherein the measured oil temperature change amount is a maximum temperature change amount determined according to the engine oil temperature measurement value, and
wherein the modeled oil temperature change amount is a maximum temperature change amount determined according to the engine oil temperature estimated by the temperature change model.

4. The method of claim 1, further including: prior to the determining the measured oil temperature change amount according to the engine oil temperature measurement value and prior to the determining the modeled oil temperature change amount according to the temperature change model,
determining whether a diagnosis condition for determining whether the engine oil replacement has occurred is satisfied.

5. The method of claim 4,
wherein the diagnosis condition includes at least one of a condition that the engine turned-off period is within a predetermined reference period, a condition that a sensor connected to the controller and configured for detecting the engine oil temperature is in a normal state, and a condition that the engine oil temperature at the engine turned-off time point is above a predetermined reference temperature.

6. The method of claim 2, wherein the determining that the engine oil replacement event has occurred includes storing engine oil replacement information in a memory.

7. The method of claim 1, wherein the temperature information related to the engine includes at least one of an ambient temperature, a coolant temperature, and the engine oil temperature.

8. The method of claim 1, wherein the controller includes:
a processor; and
a non-transitory storage medium on which a program for performing the method of claim 1 is recorded and executed by the processor.

9. A non-transitory computer readable medium on which a program for performing the method of claim 1 is recorded.

10. An apparatus of detecting engine oil replacement, the apparatus comprising:
a controller configured for determining an engine turned-off period and determining whether an engine oil replacement event has occurred during the engine turned-off period; and
a temperature change model that estimates an engine oil temperature without the engine oil replacement event according to the engine turned-off period, temperature information related to an engine at an engine turned-off time point, and temperature information related to the engine at a turned-on time point of the engine,
wherein the controller is configured to determine whether the engine oil replacement event has occurred by comparing a reference temperature with a difference value between a measured oil temperature change amount determined according to an engine oil temperature measurement value and a modeled oil temperature change amount determined according to the temperature change model.

11. The apparatus of claim 10, wherein the controller is configured to:
periodically receive the engine oil temperature from a temperature sensor that is connected to the controller and configured to measure the engine oil temperature;
determine a plurality of temperature change amounts for unit time during the engine turned-off period; and
determine the measured oil temperature change amount as a maximum temperature change amount among the plurality of temperature change amounts.

12. The apparatus of claim 11, wherein the controller is configured to:
estimate an engine oil temperature change during the engine turned-off period using the temperature change model;
determine a plurality of temperature change amounts for unit time according to the estimated engine oil temperature; and
determine the modeled oil temperature change amount as a maximum temperature change amount among the plurality of temperature change amounts for unit time determined according to the estimated engine oil temperature.

13. The apparatus of claim 12, wherein the temperature information related to the engine includes at least one of an ambient temperature, a coolant temperature, and the engine oil temperature.

14. The apparatus of claim 12, wherein the controller is configured to determine that the engine oil replacement event has occurred upon concluding that the difference value between the measured oil temperature change amount and the modeled oil temperature change amount is greater than the reference temperature.

15. The apparatus of claim 14,
wherein the measured oil temperature change amount is a maximum temperature change amount determined according to the engine oil temperature measurement value, and
wherein the modeled oil temperature change amount is a maximum temperature change amount determined according to the engine oil temperature estimated by the temperature change model.

16. The apparatus of claim 14, wherein the controller is configured to store engine oil replacement information in a memory, to reset engine oil replacement timing, and to display the reset engine oil replacement timing to a user interface.

17. The apparatus of claim 10,
wherein the controller is configured to determine whether the engine oil replacement event has occurred upon concluding that a diagnosis condition for determining whether the engine oil replacement has occurred is satisfied; and
wherein the diagnosis condition includes at least one of a condition that the engine turned-off period is within a predetermined reference period, a condition that a sensor connected to the controller and configured for detecting the engine oil temperature is in a normal state, and a condition that the engine oil temperature at the engine turned-off time point is above a predetermined reference temperature.
